(19) United States
(12) Patent Application Publication
(10) Pub. No.: US 2012/0170800 A1
(43) Pub. Date: Jul. 5, 2012

(54) SYSTEMS AND METHODS FOR CONTINUOUS PHYSICS SIMULATION FROM DISCRETE VIDEO ACQUISITION

(75) Inventors: João Pedro Gomes da Silva Frazão, Lisboa (PT); Antão Bastos Carrico Vaz de Almada, Lisboa (PT); Rui Miguel Pereira Silvestre, Barreiro (PT); Nuno Ricardo Sequeira Cardoso, Lisboa (PT); Ivan de Almeida Soares Franco, Almada (PT)

(73) Assignee: YDreams - Informatica, S.A., Caparica (PT)

(21) Appl. No.: 12/981,622

(22) Filed: Dec. 30, 2010

(51) Int. Cl. G06K 9/00

(52) U.S. Cl. 382/103

(57) ABSTRACT

A computer implemented method for processing video is provided. A first image and a second image are captured by a camera. A feature present in the first camera image and the second camera image is identified. A first location value of the feature within the first camera image is identified. A second location value of the feature within the second camera image is identified. An intermediate location value of the feature based at least in part on the first location value and the second location value is determined. The intermediate location value and the second location value are communicated to a physics simulation.

### TECHNICAL FIELD

The present disclosure relates graphics processing and augmented reality systems.

### BACKGROUND

At present, augmented reality systems allow for various forms of input from real world actions including camera input. As used herein the term augmented reality (AR) system refers to any system operating a three dimensional simulation with input from one or more real-world actors. The AR system may, for example, operate a virtual game of handball wherein one or more real people, the participants, may interact with a virtual handball. In this example, a video display may show a virtual wall and a virtual ball moving towards or away from the participants. A participant watches the ball and attempts to “hit” the ball as it comes towards the participant. A video camera captures the participant's location and can detect contact. Difficulties arise, however, capturing the participant's position and motion in a real-time and realistic manner.

### SUMMARY

In accordance with the teachings of the present disclosure, disadvantages and problems associated with existing augmented reality and virtual reality systems have been reduced.

In certain embodiments, a computer implemented method for processing video is provided. The method includes steps of capturing a first image and a second image from a camera, identifying a feature present in the first camera image and the second camera image, determining a first location value of the feature within the first camera image, determining a second location value of the feature within the second camera image, estimating an intermediate location value of the feature based at least in part on the first location value and the second location value, and communicating the intermediate location value and the second location value to a physics simulation.

In other embodiments, a computer implemented method for processing video is provided. The method includes steps of capturing a current image from a camera wherein the current camera image comprises a current view of a participant, retrieving, from a memory, a previous image comprising a previous view of the participant, determining a first location value of the participant within the previous image, determining a second location value of the participant in the current camera image and in the previous image, estimating an intermediate location value of the participant based at least in part on the first location value and the second location value, communicating the intermediate location value and the second location value to a physics simulation.

In still other embodiments, a computer system is provided for processing video. The computer system comprises a camera configured to capture a current image, a memory configured to store a previous image and the current image, a means for determining a first location value of the participant within the previous image, a means for determining a second location value of the participant in the current camera image and in the previous image, a means for estimating an intermediate location value of the participant based at least in part on the first location value and the second location value, and a means for communicating the intermediate location value and the second location value to a physics simulation.

In further embodiments, a tangible computer readable medium is provided. The medium comprises software that, when executed on a computer, is configured to capture a current image from a camera wherein the current camera image comprises a current view of a participant, retrieve, from a memory, a previous image comprising a previous view of the participant, determine a first location value of the participant within the previous image, determine a second location value of the participant in the current camera image and in the previous image, estimate an intermediate location value of the participant based at least in part on the first location value and the second location value, and communicate the intermediate location value and the second location value to a physics simulation.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an AR system, according to an example embodiment of the present disclosure;

FIG. 2 illustrates participant interaction with a virtual element at three successive points in time, according to certain embodiments of the present disclosure;

FIG. 3 illustrates a method of processing a video stream according to certain embodiments of the present invention; and

FIG. 4 illustrates the interaction of processed video and a simulation, according to certain embodiments of the present invention.

### DETAILED DESCRIPTION

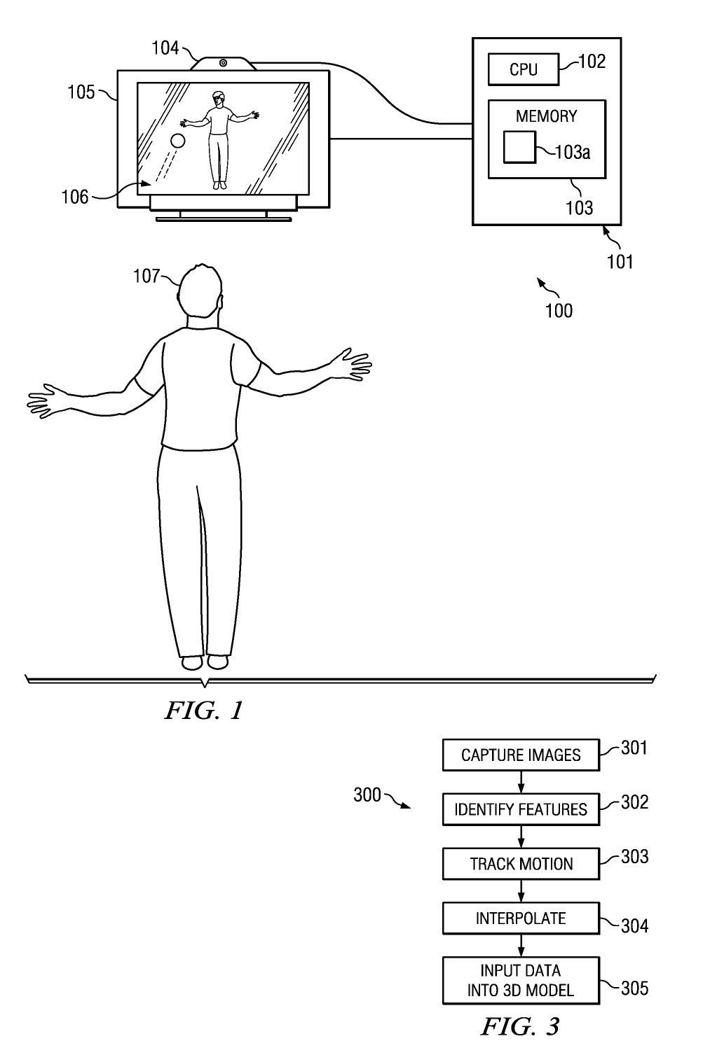

Preferred embodiments and their advantages over the prior art are best understood by reference to FIGS. 1-4 below.

FIG. 1 illustrates an AR system, according to an example embodiment of the present disclosure. System 100 may include computer 101, camera 104, and display 105. System 100 may include central processing unit (CPU) 102 and memory 103. Memory 103 may include one or more software modules 103a. Camera 104 may capture a stream of pictures (or frames of video) that may include images of participant 107.

Computer 101 may be, for example, a general purpose computer such as an Intel™ architecture personal computer, a UNIX™ workstation, an embedded computer, or a mobile device such as a smartphone or tablet. CPU 102 may be an x86-based processor, an ARM™ processor, a RISC processor, or any other processor sufficiently powerful to perform the necessary computation and data transfer needed to produce a representational or realistic physics simulation and to render the graphical output. Memory 103 may be any form of tangible computer readable memory such as RAM, MRAM, ROM, EEPROM, flash memory, magnetic storage, and optical storage. Memory 103 may be mounted within computer 101 or may be removable.

Software modules 103a provide instructions for computer 101. Software modules 103a may include a 3D physics engine for controlling the interaction of objects (real and virtual) within a simulation. Software modules 103a may include a user interface for configuring and operating an interactive AR system. Software modules 103a may include modules for performing the functions of the present disclosure, as described herein.

Camera 104 provides video capture for system 100. Camera 104 captures a sequence of images, or frames, and provides that sequence to computer 101. Camera 104 may be a stand alone camera, a networked camera, or an integrated camera (e.g., in a smartphone or all-in-one personal computer). Camera 104 may be a webcam capturing 640×480 video at 30 frames per second (fps). Camera 104 may be a handheld video camera capturing 1024×768 video at 60 fps. Camera 104 may be a high definition video camera (including a video capable digital single lens reflex camera) capturing 1080p video at 24, 30, or 60 fps. Camera 104 captures video of participant 107. Camera 104 may be a depth-sensing video camera capturing video associated with depth information in sequential frames.

Participant 107 may be a person, an animal, or an object (e.g., a tennis racket or remote control car) present within the field of view of the camera. Participant 107 may refer to a person with an object in his or her hand, such as a table tennis paddle or a baseball glove.

In some embodiments, participant 107 may refer to a feature other than a person. For example, participant 107 may refer to a portion of a person (e.g., a hand), a region or line in 2D space, or a region or surface in 3D space. In some embodiments, a plurality of cameras 104 are provided to increase the amount of information available to more accurately determine the position of participants and/or features or to provide information for determining the 3D position of participants and/or features.

Display 105 allows a participant to view simulation output 106 and thereby react to or interact with it. Display 105 may be a flat screen display, projected image, tube display, or any other video display. Simulation output 106 may include purely virtual elements, purely real elements (e.g., as captured by camera 104), and composite elements. A composite element may be an avatar, such as an animal, with an image of the face of participant 107 applied to the avatar's face.

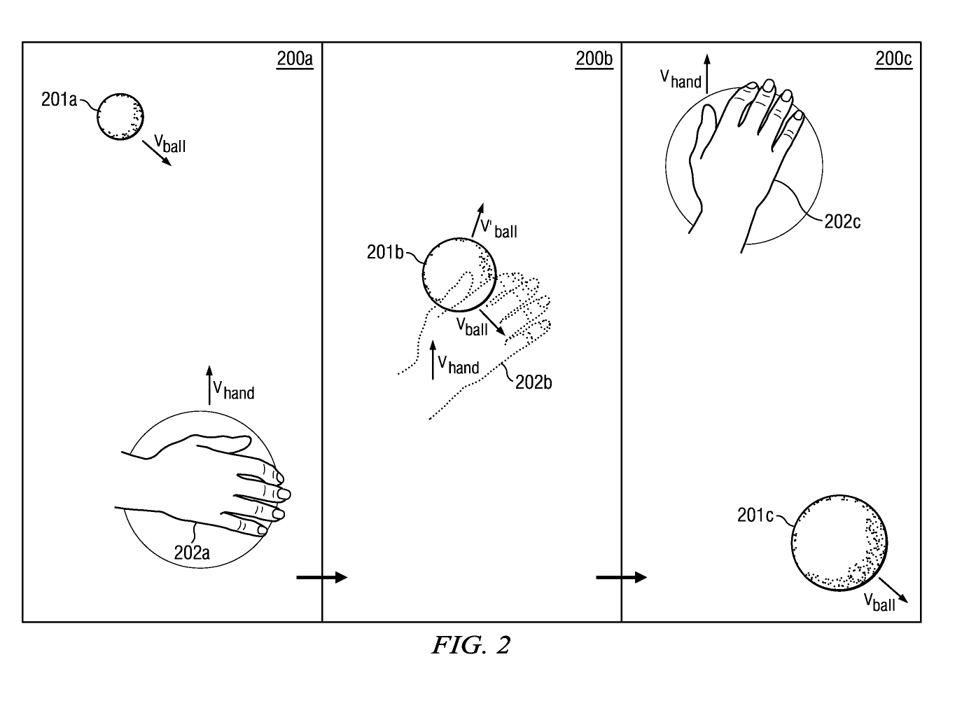

FIG. 2 illustrates participant interaction with a virtual element at three successive points in time, according to certain embodiments of the present disclosure. Scenes 200 illustrate the relative positions of virtual ball 201 and participant hand 202 at each of three points in time. Scenes 200 need not represent the output of display 105. The three points in time represent three successive frames in a physics simulation. Scenes 200a and 200c align with the frame rate of camera 104, allowing acquisition of the position of hands 202a and 202c. Thus, the simulation frame rate is approximately twice that of the video capture system and scene 200b is processed without updated position information of the participant's hand.

In scene 200a, ball 201a is distant from the participant (and near to the point of view of camera 104) and moving along vector v_{ball} generally across scene 200a and downward. Hand 202a is too low to contact ball 201a traveling along its current path, so participant is raising his hand along vector v_{hand} to meet the ball. In scene 200b, ball 201b is roughly aligned in three dimensional space with hand 202b. In scene 200c, ball 201c is lower and further from the point of view of camera 104 while participant hand 202c is much higher than the ball. Further, because ball 201c is still moving along vector v_{ball}, it is clear that the simulation did not register contact between ball 201b and hand 202b, otherwise ball 201c would be traveling along a different vector, likely back towards the point of view of the camera.

FIG. 3 illustrates a method of processing a video stream according to certain embodiments of the present invention. Method 300 includes steps of capturing images 301, identifying participant location 302, tracking motion 303, interpolating values 304, and inputting data into the three dimensional model 305. At a high-level, the process described herein executes an optical flow algorithm to identify features in a previously captured frame of video and tracks the movement of those features in the current video frame. In the process, displacement vectors may be calculated for each feature and may be subsequently used to estimate an intermediate, intra-frame position for each feature.

Capturing images 301 comprises the capture of a stream of images from camera 104. In some embodiments, each captured image is a full frame of video, with one or more bits per pixel. In some embodiments, the stream of images is compressed video with a series of key frames with one or more predicted frames between key frames. In some embodiments, stream of images is interlaced such that each successive frame has information about half of the pixels in a full frame. Each frame may be processed sequentially with information extracted from the current frame being analyzed in conjunction with information extracted from the previous frame. In some embodiments, more than two image frames may be analyzed together to more accurately capture the movement of the participant over a broader window of time.

Step 302

Identifying participant location 302 evaluates an image to determine which portions of the image represent the participant and/or features. This step may identify multiple participants or segments of the participant (e.g., torso, arm, hand, or fingers). In some embodiments, the term participant may refer to an animal (that may or may not interact with the system) or to an object, e.g., a baseball glove or video game controller. The means for identifying the participant's location may be implemented with one of a number of algorithms (examples identified below) programmed into software module 103a and executing on CPU 102.

In some embodiments, an image may be scanned for threshold light or color intensity values, or specific colors. For example, a well-lit participant may be standing in front of a dark background or a background of a specific color. In these embodiments, a simple filter may be applied to extract out the background. Then the edge of the remaining data forms the outline of the participant, which identifies the position of the participant.

In the following example algorithms, the current image may be represented as a function ƒ(x, y) where the value stored for each (x, y) coordinate may be a light intensity, a color intensity, or a depth value.

In some embodiments, a Determinant of Hessian (DoH) detector is provided as a means for identifying the participant's location. The DoH detector relies on computing the determinant of the Hessian matrix constructed using second order derivatives for each pixel position. If we consider a scale-space Gaussian function:

$$g ( x , y ; t ) = \frac{1}{2 π t} {e}^{- ( {x}^{2} + {y}^{2} ) / 2 t}$$

For a given image ƒ(x, y), its Gaussian scale-space representation L(x, y;t), can be derived by convolving the original ƒ(x, y) by g(x, y;t) at a given scale t>0:

L(x,y;t)=g(x,y;t)\textcircled{x}f(x,y)

Therefore, the Determinant of Hessian, for a scale-space image representation L(x, y;t) can be computed for every pixel position, in the following manner:

h(x,y;t)=t²(LₓₓL_{yy}−L_{xy}²)

Features are detected at pixel positions corresponding to local maximums in the resulting image, and can be thresholded by h>e, e being an empirical threshold value.

In some embodiments, a Laplacian of Guassians feature detector is provided as a means for identifying the participant's location. Given a scale-space image representation L(x,y;t) (see above), the Laplacian of Gaussians (LoG) detector computes the Laplacian for every pixel position:

∇²L=Lₓₓ+L_{yy}

The Laplacian of Gaussians feature detector is based on the Laplacian operator, which relies on second order derivatives. As a result, it is very sensitive to noise, but very robust to view changes and image transformations.

Features are extracted at positions where zero-crossing occurs (when the resulting convolution by the Laplacian operation changes sign, i.e., crosses zero).

Values can also be threshold by L₂∇>e if positive, and L₂∇<−e if negative, where e is an empirical threshold value.

In some embodiments, other methods may be used to determine participant location 302, including the use of eigenvalues, multi-scale Harris operator, Canny edge detector, Sobel operator, scale-invariant feature transform (SIFT), and/or speeded up robust features (SURF).

Step 303

Tracking motion 303 evaluates data relevant to a pair of images (e.g., the current frame and the previous frame) to determine displacement vectors for features in the images using an optical flow algorithm. The means for tracking motion may be implemented with one of a number of algorithms (examples identified below) programmed into software module 103a and executing on CPU 102.

In some embodiments, the Lucas-Kanade method is utilized as a means for tracking motion. This method assumes that the displacement of the image contents between two nearby instants (frames) is small and approximately constant within a neighborhood of the point p under consideration. Thus, the optical flow equation can be assumed to hold for all pixels within a window centered at p. Namely, the local image flow (velocity) vector (Vₓ,V_{y}) must satisfy:

$$\begin{matrix}{I}_{x} ( {q}_{1} ) {V}_{x} + {I}_{y} ( {q}_{1} ) {V}_{y} = - {I}_{t} ( {q}_{1} ) \\ {I}_{x} ( {q}_{2} ) {V}_{x} + {I}_{y} ( {q}_{2} ) {V}_{y} = - {I}_{t} ( {q}_{2} ) \\ ⋮ \\ {I}_{x} ( {q}_{n} ) {V}_{x} + {I}_{y} ( {q}_{n} ) {V}_{y} = - {I}_{t} ( {q}_{n} )\end{matrix}$$

where q₁,q₂, . . . , qₙ are the pixels inside the window, and Iₓ(qᵢ),I_{y}(qᵢ),Iₜ(qᵢ) are the partial derivatives of the image I with respect to position x, y and time t, evaluated at the point qᵢ and at the current time.

These equations can be written in matrix form Av=b, where

$$A = [ \begin{matrix}{I}_{x} ( {q}_{1} ) & {I}_{y} ( {q}_{1} ) \\ {I}_{x} ( {q}_{2} ) & {I}_{y} ( {q}_{2} ) \\ ⋮ & ⋮ \\ {I}_{x} ( {q}_{n} ) & {I}_{y} ( {q}_{n} )\end{matrix} ] , \\ v = [ \begin{matrix}{V}_{x} \\ {V}_{y}\end{matrix} ] , \\ and b = [ \begin{matrix}- {I}_{t} ( {q}_{1} ) \\ - {I}_{t} ( {q}_{2} ) \\ ⋮ \\ - {I}_{t} ( {q}_{n} )\end{matrix} ]$$

This system has more equations than unknowns and thus it is usually over-determined. The Lucas-Kanade method obtains a compromise solution by the weighted least squares principle. Namely, it solves the 2×2 system:

A^{T}Av=A^{T}b

or

v=(A^{T}A)⁻¹A^{T}b

where A^{T} is the transpose of matrix A. That is, it computes

$$[ \begin{matrix}{V}_{x} \\ {V}_{y}\end{matrix} ] = {[ \begin{matrix}{\sum }_{i} {{I}_{x} ( {q}_{i} )}^{2} & {\sum }_{i} {I}_{x} ( {q}_{i} ) {I}_{y} ( {q}_{i} ) \\ {\sum }_{i} {I}_{x} ( {q}_{i} ) {I}_{y} ( {q}_{i} ) & {\sum }_{i} {{I}_{y} ( {q}_{i} )}^{2}\end{matrix} ]}^{- 1} [ \begin{matrix}- {\sum }_{i} {I}_{x} ( {q}_{i} ) {I}_{t} ( {q}_{i} ) \\ - {\sum }_{i} {I}_{y} ( {q}_{i} ) {I}_{t} ( {q}_{i} )\end{matrix} ]$$

with the sums running from i=1 to n. The solution to this matrix system gives the displacement vector in x and y: V_{xy}.

In some embodiments, the displacement is calculated in a third dimension, z. Consider the depth image D₍ₙ₎(x,y), where n is the frame number. The velocity (V_{z}) of point P_{xy} in dimension z may be calculated by using an algorithm such as:

V_{z}=D₍ₙ₋₁₎(P_{xy}+V_{xy})−D₍ₙ₋₁₎(P_{xy})

where D(n) and D(n−1) are images from a latter frame and a former frame, respectively; and V_{xy} is computed using the above method or some alternate method.

Incorporating this dimension in vector V_{xy} computed as described above, V_{xy}, is obtained which is the displacement vector for 3D space.

Step 304

Interpolating values 304 determines inter-frame positions of participants and/or features. This step may determine inter-frame positions at one or more points in time intermediate to the points in time associated with each of a pair of images (e.g., the current frame and the previous frame). The use of the term “interpolating” is meant to be descriptive, but not limiting as various nonlinear curve fitting algorithms may be employed in this step. The means for estimating an intermediate location value may be implemented with one of a number of algorithms (an example is identified below) programmed into software module 103a and executing on CPU 102.

In certain embodiments, the following formula for determining inter-frame positions by linear interpolation is employed:

$$p ( n ) = p ( n - 1 ) + \frac{n \times ∇}{N}$$

where
p(n)=position at latter moment n
p(n−1)=position at former moment n−1
\vec{V}=velocity vector
N=number of iterations per frame

In some embodiments, the position of the participant is recorded over a period of time developing a matrix of position values. In these embodiments, a least squares curve fitting algorithm may be employed, such as the Levenberg-Marquardt algorithm.

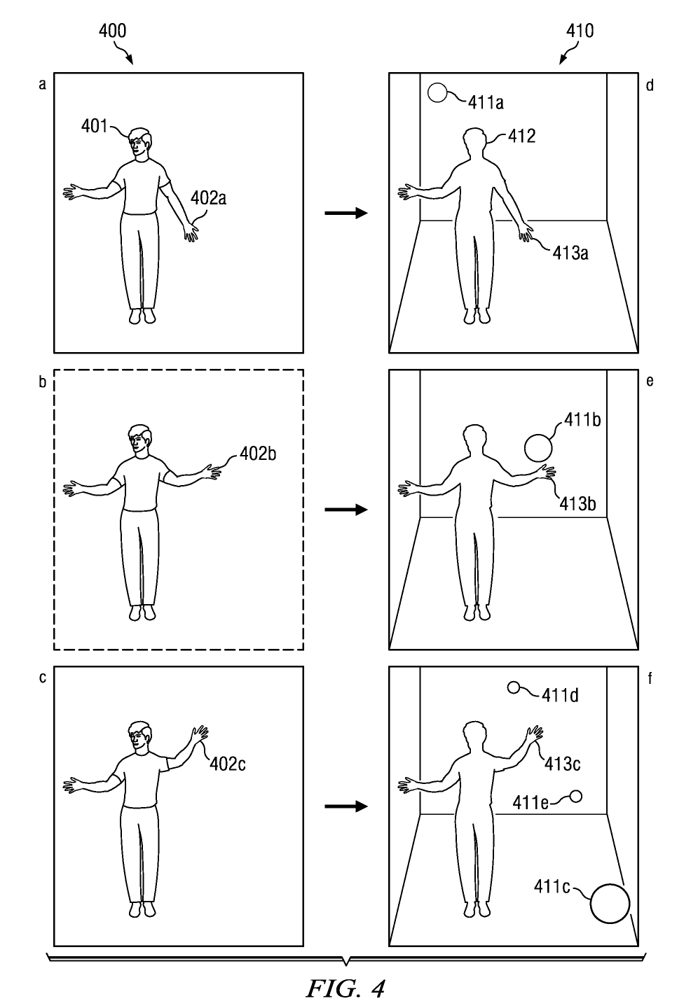

FIG. 4 illustrates the interaction of processed video and a simulation, according to certain embodiments of the present invention. FIG. 4 illustrates video frames 400 (individually labeled a-c) and simulation frames 410 (individually labeled d-f). Each video frame 400 includes participant 401 with a hand at position 402. Each simulation frame 410 includes virtual ball 411 and virtual representation of participant 412 with hand position 413.

Video frames a and c represent images captured by the camera. Video frame b illustrates the position of hand 402b at a time between the time that frames a and c are captured. Simulation frames d-f represent the state of a 3D physics simulation after three successive iterations. In FIG. 4, the frame rate of the camera is half as fast as the frame rate of the simulation. Simulation frame e illustrates the result of the inter-frame position determination process wherein the simulation accurately represents the position of hand 413b even though the camera never captured an image of the participant's hand when it was in the corresponding position 402b. Instead, the system of the present disclosure determined the likely position of the participant's hand based on information from video frames a and c.

Virtual ball 411 is represented in several different positions. The sequence 411a, 411b, and 411c represents the motion of virtual ball 411 assuming that intermediate frame b was not captured. In this sequence, virtual ball 411 moves from above, in front of, and to the left of the participant to below, behind, and to the right of the participant. Alternatively, the sequence 411a, 411b, and 411d represents the motion of virtual ball 411 in view of intermediate frame b where a virtual collision of participant's hand 413b and virtual ball 411b results in a redirection of the virtual ball to location 411d, which is above and almost directly in front of participant 412. This position of virtual ball 411d was calculated not only from a simple collision, but also from the calculated trajectory of participant hand 413 as calculated based on the movement registered from frames a and c as well as inferred properties of participant hand 413.

In some embodiments, the position and movement of participant hand 413 is registered in only two dimensions (and thus assumed to be within a plane perpendicular to the view of the camera). If participant hand 411 is modeled as a frictionless object, then the collision with virtual ball 411 will result in a perfect bounce off of a planar surface. In such case, 411e is shown to be near the ground and in front of and to the right of participant 412.

In certain embodiments, the reaction of virtual ball 411 to the movement of participant hand 413 (e.g., V_{hand}) may depend on the inferred friction of participant hand 413. This friction would impart a additional lateral forces on virtual ball 411 causing V′_{ball} to be asymmetric to V_{ball} as reflected in the plane of the participant. For example, virtual ball location 411d is above and to the left of location 411e as a result of the additional inferred lateral forces. If participant hand 413 were recognized to be a table tennis racket, the inferred friction may be higher resulting in a greater upward component of the bounce vector, V′_{ball}.

In still other embodiments, a three dimensional position of participant hand 413a and 413c may be determined or inferred. The additional dimension of data may add to the realism of the physics simulation and may used in combination with an inferred friction value of participant hand 413 to determine V′_{ball}.

In addition to the 2D or 3D position of participant 412 and participant's hand 413, the system may perform an additional 3D culling step to estimate a depth value of the participant and/or the participant's hand to provide additional realism in the 3D simulation. Techniques for this culling step are described in the copending patent application entitled “Systems and Methods for Simulating Three-Dimensional Virtual Interactions from Two-Dimensional Camera Images,” Ser. No. 12/364,122 (filed Feb. 2, 2009).

In each of these embodiments, the forces imparted on virtual ball 411 are fed into the physics simulation to determine the resulting position of virtual ball 411.

For the purposes of this disclosure, the term exemplary means example only. Although the disclosed embodiments are described in detail in the present disclosure, it should be understood that various changes, substitutions and alterations can be made to the embodiments without departing from their spirit and scope.

What is claimed is:

1. A computer implemented method for processing video comprising:
capturing a first image and a second image from a camera;
identifying a feature present in the first camera image and the second camera image;
determining a first location value of the feature within the first camera image;
determining a second location value of the feature within the second camera image;
estimating an intermediate location value of the feature based at least in part on the first location value and the second location value; and
communicating the intermediate location value and the second location value to a physics simulation.

2. A computer implemented method for processing video comprising:
capturing a current image from a camera wherein the current camera image comprises a current view of a participant;
retrieving, from a memory, a previous image comprising a previous view of the participant;
determining a first location value of the participant within the previous image;
determining a second location value of the participant in the current camera image and in the previous image;
estimating an intermediate location value of the participant based at least in part on the first location value and the second location value; and
communicating the intermediate location value and the second location value to a physics simulation.

3. The computer implemented method of claim 2, further comprising:
after communicating the intermediate location value and the second location value to a physics simulation, designating the current image as the previous image.

4. The computer implemented method of claim 2, further comprising displaying a representation of a virtual object on the video monitor wherein the participant can view a current trajectory of the virtual object as displayed on the video monitor.

5. The computer implemented method of claim 4, further comprising identifying a virtual collision between the participant and the virtual object based at least in part on the intermediate location value communicated to the physics simulation.

6. The computer implemented method of claim 5, further comprising displaying the virtual object traveling along a post-collision trajectory different than the previously displayed current trajectory.

7. The computer implemented method of claim 2 further comprising:
determining a movement vector of the participant based at least in part on the first location value and the second location value; and
communicating the movement vector of the participant to a physics simulation.

8. The computer implemented method of claim 7 wherein the movement vector is three-dimensional.

9. A computer system for processing video comprising:
a camera configured to capture a current image;
a memory configured to store a previous image and the current image;
a means for determining a first location value of the participant within the previous image;
a means for determining a second location value of the participant in the current camera image and in the previous image;
a means for estimating an intermediate location value of the participant based at least in part on the first location value and the second location value; and
a means for communicating the intermediate location value and the second location value to a physics simulation.

10. A tangible computer readable medium comprising software that, when executed on a computer, is configured to:
capture a current image from a camera wherein the current camera image comprises a current view of a participant;
retrieve, from a memory, a previous image comprising a previous view of the participant;
determine a first location value of the participant within the previous image;
determine a second location value of the participant in the current camera image and in the previous image;
estimate an intermediate location value of the participant based at least in part on the first location value and the second location value; and
communicate the intermediate location value and the second location value to a physics simulation.
